(19) United States
(12) Patent Application Publication
(10) Pub. No.: US 2015/0320007 A1
(43) Pub. Date: Nov. 12, 2015

(54) VERTICAL VAT WITH COUNTER ROTATING AGITATOR PANELS

(71) Applicant: TETRA LAVAL HOLDINGS & FINANCE S.A., Pully (CH)

(72) Inventors: Thomas R. HAMM, Fond du Lac, WI (US); Michael Olson, Montrose, MN (US)

(73) Assignee: TETRA LAVAL HOLDINGS & FINANCE S.A., Pully (CH)

(21) Appl. No.: 14/275,186

(22) Filed: May 12, 2014

(51) Int. Cl. A01J 25/02

(52) U.S. Cl. CPC A01J 25/02

(57) ABSTRACT

A vertical vat comprising a first shaft provided with at least one agitator panel, a second shaft provided with at least one agitator panel, wherein said first shaft and said second shaft are arranged to counter rotate.

### TECHNICAL FIELD

The invention generally relates to the field of food processing. More particularly, a vertical vat is disclosed with improved cutting and/or stirring functionality.

### BACKGROUND DISCUSSION

In large scale semi-hard cheese production it is today common practice to use cheese vats for cutting and stirring curd. By tradition, but also because different types of cheeses require different processing, a number of different types of cheese vats are available on the market. As an example, in the US it is common to use cheese vats with two shafts provided with agitator panels, while in Europe it is more common to use cheese vats with a single shaft provided with agitator panels. Further, the cheese vats may be horizontal cheese vats with the shafts placed horizontally or vertical cheese vats with the shafts placed vertically.

In order to provide for an easy switch between cutting and stirring the agitator panels, which most often comprise a steel frame holding a number of steel elements, are on one side provided with sharpened edges and on the other side provided with blunt edges. When rotating in a first direction the sharpened edges are swept through the curd such that this is cut into minor pieces, and, when rotating in a second direction, opposite to the first direction, the other side of the agitator panel provided with blunt edges is swept through the curd such that the curd is stirred. By switching between cutting and stirring according to a pre-set scheme a curd mass with a uniform curd grain size can be formed, which is important to get a good texture of the final cheese.

Apart from making sure that there is a uniform curd grain size distribution it is important to make sure that the cheese yield, i.e. the ratio of the produced amount of cheese per volume of input milk, is kept at a high level. It has been shown that by optimizing the cutting and stirring steps of the cheese making process this yield can be improved. Therefore, in order to stay competitive it is in the interest of most cheese makers to assure that they have efficient cheese vats.

### SUMMARY

Accordingly, the vat and method disclosed here preferably seeks to mitigate, alleviate or eliminate one or more of the above-identified deficiencies in the art and disadvantages singly or in any combination and solves at least the above mentioned problems.

According to a first aspect a vertical cheese vat is provided comprising a first shaft provided with at least one agitator panel, a second shaft provided with at least one agitator panel, wherein said first shaft and said second shaft are arranged to counter rotate.

The at least one agitator panel of said first shaft and said at least one agitator panel of said second shaft may be arranged to sweep a common swept volume.

The first shaft and said second shaft may be provided with at least two agitator panels each, wherein said at least two agitator panels are rotationally spaced apart from each other.

The first shaft and said second shaft may be provided with two agitator panels each, said two agitator panels being 180 degrees spaced apart from each other.

One of said at least two agitator panels of said first shaft and one of said at least two agitator panels of said second shaft may be arranged to sweep said common swept volume at the same time.

The at least one agitator panel of said first shaft and/or said at least one agitator panel of said second shaft may comprise a number of cutting/stirring elements.

The at least one agitator panel of said first shaft and/or said at least one agitator panel of said second shaft may have a curved surface. A concave side of said curved surface may be provided with sharpened edges. A convex side of said curved surface may be provided with blunt edges.

The at least one agitator panel of said first shaft may be arranged such that a lower part of said agitator panel moves ahead of an upper part of said agitator panel such that particles are pushed upwards when sweeping.

The first shaft and second shaft may rotate at a speed of 7 rounds (rotations) per minute or less.

According to a second aspect a shaft is provided with at least one agitator panel, wherein said at least one agitator panel is inclined with respect to said shaft.

According to a third aspect a method is provided comprising feeding a liquid or semi-liquid food product into a vertical vat according to the first aspect, stirring and/or cutting said food product by sweeping said at least one agitator panel of said first shaft and said at least one agitator panel of said second shaft through said food product.

### BRIEF DESCRIPTION OF THE DRAWINGS

The above, as well as additional objects, features and advantages of the vat and method disclosed here, will be better understood through the following illustrative and non-limiting detailed description of preferred embodiments, with reference to the appended drawings, wherein:

FIG. 1 illustrates a vertical dual shaft cheese vat.

FIG. 2a and FIG. 2b illustrate another type of vertical dual shaft cheese vat from two different views.

FIG. 3a, FIG. 3b and FIG. 3c illustrate an agitator panel in different views.

FIG. 4 schematically illustrates a vertical dual shaft cheese vat with counter rotating agitator panels.

FIG. 5a and FIG. 5b schematically illustrate two top views of a dual vertical cheese vat with two agitator panels in two different stages of a cutting or stirring cycle.

FIG. 6a and FIG. 6b schematically illustrate two top views of a dual vertical cheese vat with three agitator panels in two different stages of a cutting or stirring cycle.

FIG. 7 schematically illustrates a shaft with three agitator panels.

FIG. 8 schematically illustrates a shaft with three curved agitator panels.

FIG. 9 schematically illustrates a shaft with three inclined agitator panels.

FIG. 10 is a perspective view of a portion of an agitator panel with sharpened and blunt edges.

### DETAILED DESCRIPTION

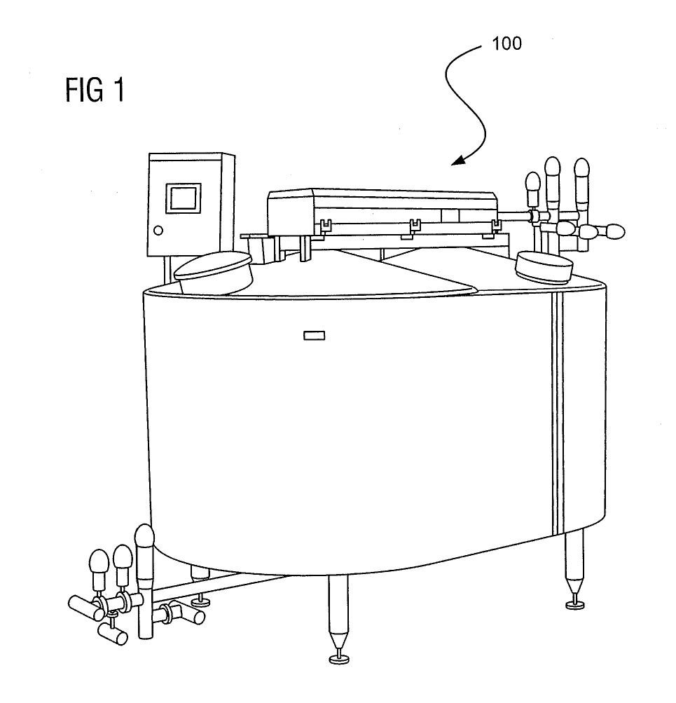

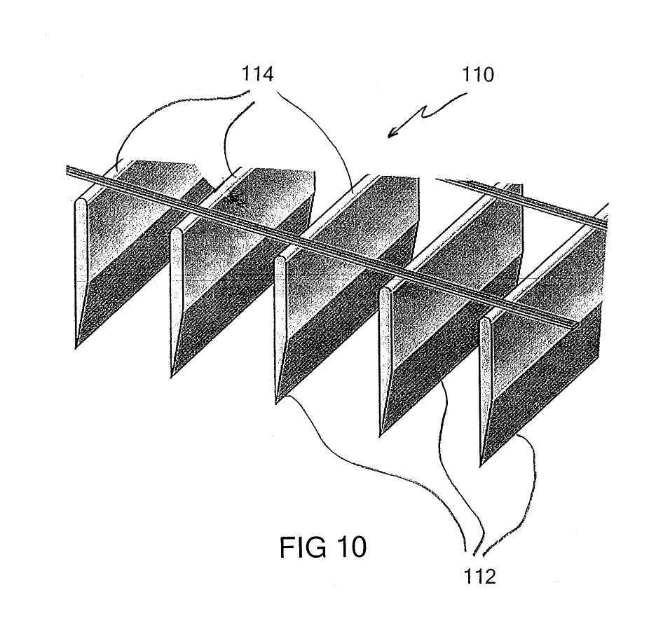

FIG. 1 illustrates an example of a vertical cheese vat 100 with dual shafts. Pre-treated milk is added to the cheese vat via connection pipes. After having added rennet, or other additive for starting the coagulation process, a curd is formed. In order to make sure that a high yield is achieved as well as that the curd size distribution is uniform the curd is cut and stirred by using agitator panels attached to the shafts. Most often, one side of each of the agitator panels is provided with sharpened edges and the other side of each agitator panel is provided with blunt edges. FIG. 10 illustrates an example of an agitator panel 110 possessing sharpened edges 112 on one side of the panel and blunt edges 114 on the opposite side of the agitator panel. The sharpened edges 112 define cutting elements on one side of the agitator panels, and the blunt edges 114 define stirring elements on the opposite side of the agitator panels. Rotating the agitator panels in one direction so that the sharpened edges 112 are at the leading end cuts the curd, and rotating the agitator panels in the opposite direction in which the blunt edges are at the leading end stirs the curd. When a uniform curd is achieved this is transported to a next step in the processing chain, e.g. a drainage column.

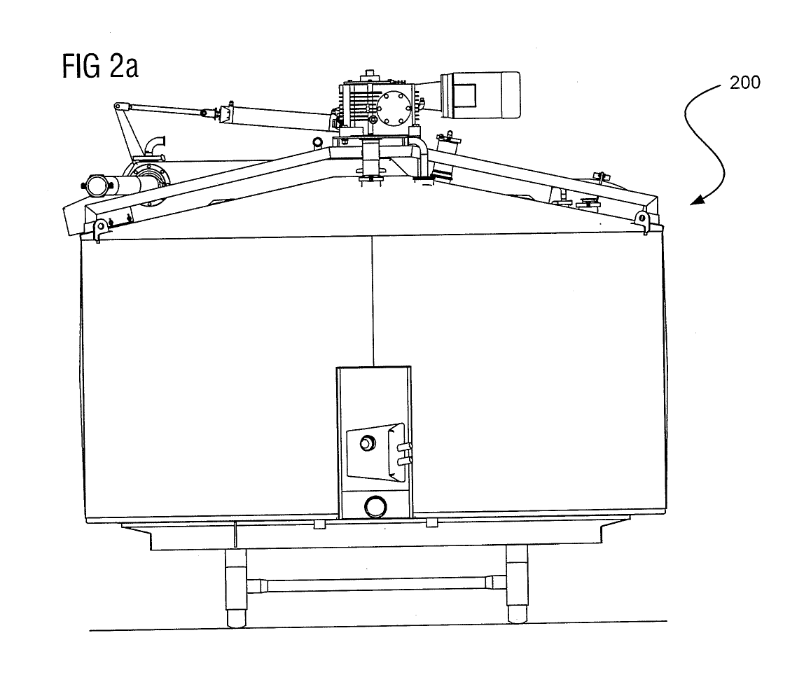

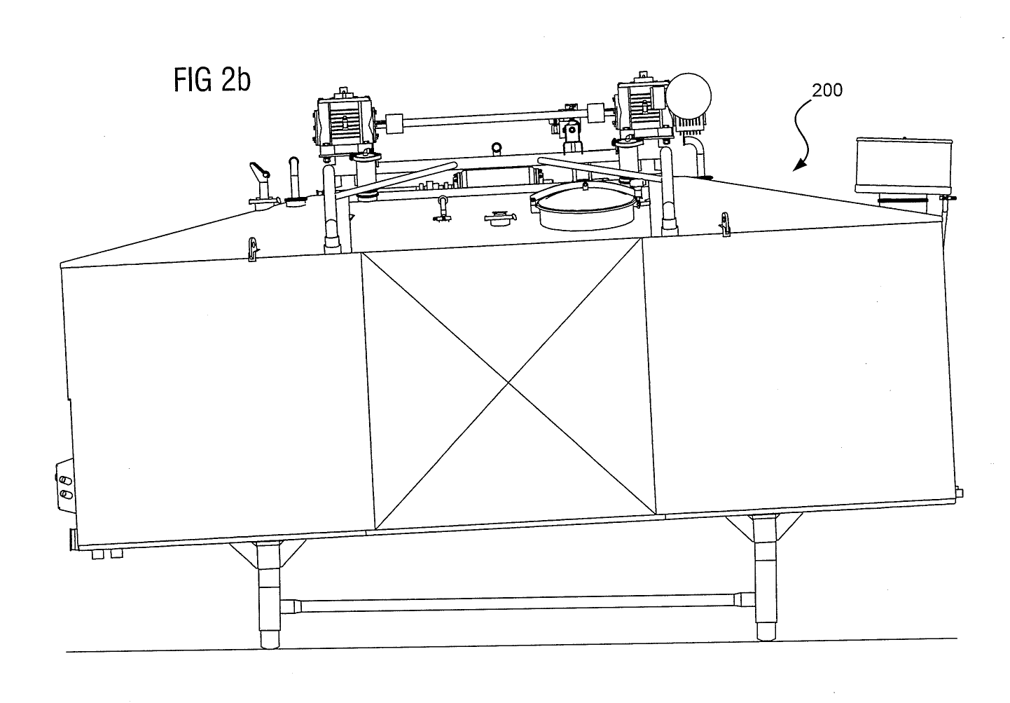

FIG. 2a and FIG. 2b illustrate another example of a vertical cheese vat 200 from a side view and a front view, respectively. As for the cheese vat 100, illustrated in FIG. 1, milk is fed into the vat and rennet is added.

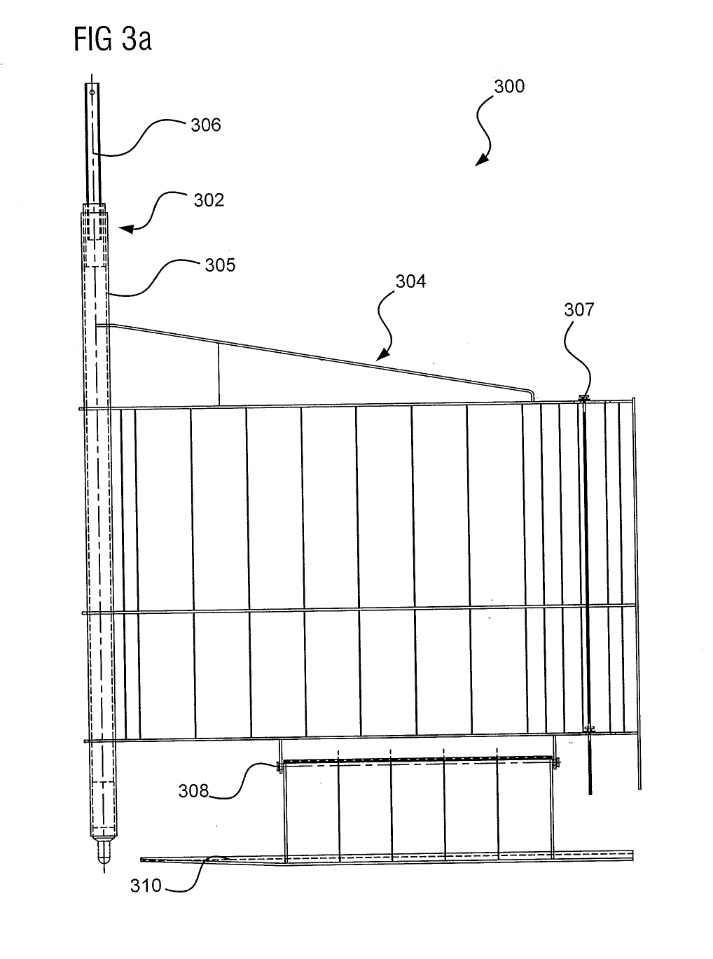

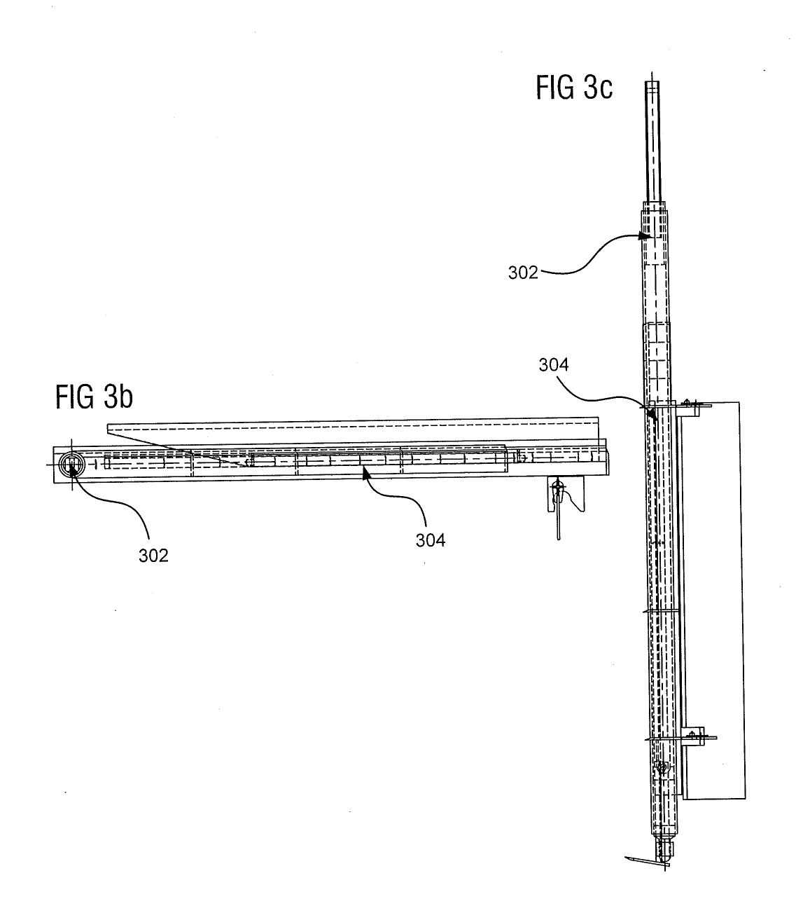

FIG. 3a, FIG. 3b and FIG. 3c illustrate a front view, a top view and a side view, respectively, of a shaft 302 provided with an agitator panel 304.

The shaft 302 is during operation placed vertically in the vat. That is, during operation of the vertical cheese vat, the shafts 302 to which the agitator panels 304 are fixed, and from which the agitator panels 304 project, are positioned vertically so that the longitudinally extending central axis of each shaft 302 is vertically oriented. Each shaft may comprise one single part, but in order to make it easier to mount and de-mount the shaft and agitator panel, the shaft may as an alternative comprise a first shaft portion 305 provided with a recess for receiving a second shaft portion 306. In this way the shaft and agitator panel can be mounted by first connecting the second shaft portion 306 to an engine or motor arranged for rotating the shaft, and then mounting the first portion 305 with the agitator panel attached thereto such that the second shaft portion 306 is placed in the recess of the first shaft portion 305. In order to make sure that the mounting and de-mounting can be made easily the depth of the recess is preferably of a dimension so that the first shaft portion can easily be lifted in place in a recess in the bottom of the vat.

Each shaft 302 is operatively connected to a motor or engine so that operation of the motor/engine rotates the shaft 302 about its vertically oriented and longitudinally extending central axis, thus moving the agitator panels inside the vat. Both shafts 302 can be operatively connected to a single common motor/engine. Alternatively, each shaft 302 can be operatively connected to a respective motor/engine.

In order to provide for that cutting and stirring can be made efficiently, such that a high yield can be achieved, the distribution of the longitudinal elements of the agitator panel may vary depending on a distance from the shaft. For instance, as illustrated, a distance between two consecutive longitudinal elements placed in the close vicinity of the shaft may be approximately half of the distance between two consecutive longitudinal elements in the middle section of the agitator panel. Further, also illustrated, a distance between two consecutive longitudinal elements in an outer section of the agitator panel, that is, the section of the agitator panel placed farthest away from the shaft, may be half the distance compared to the distance between two consecutive longitudinal elements in the middle section.

Further, the outer section, or part of the outer section, of the agitator panel 304 may be possible to connect or de-connect to the agitator panel by a connection rod 307. This is advantageous during mounting and de-mounting.

In a similar way and for the same reason, a connection rod 308 may be used for mounting or de-mounting a bottom part 310 of the agitator panel 304. The bottom part may, as illustrated, be provided with a transversal element arranged for handling curd at the bottom of the vat.

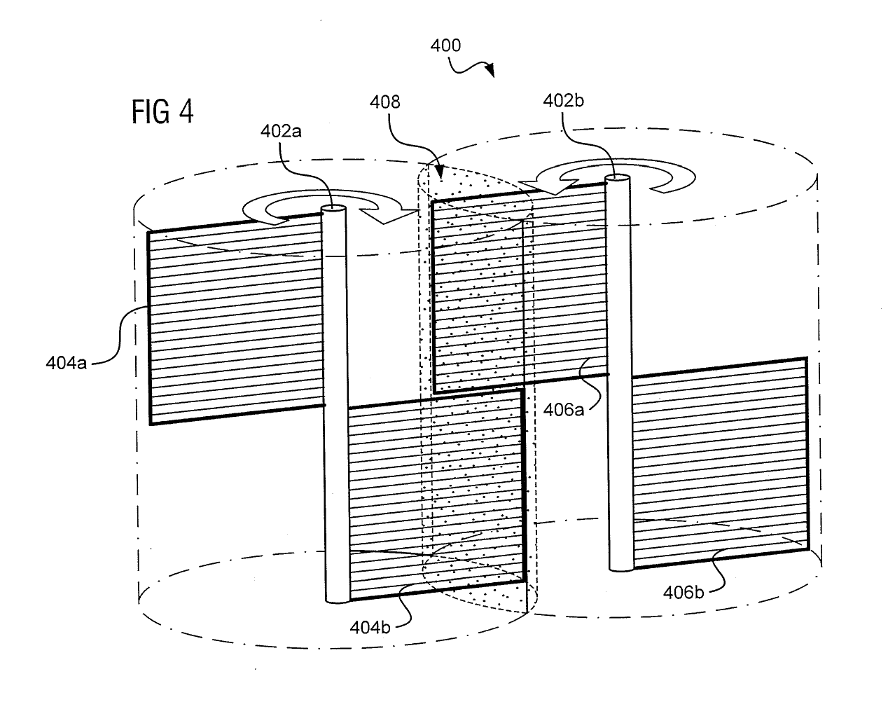

FIG. 4 generally illustrates two shafts 402a, 402b provided with two agitator panels 404a, 404b, 406a, 406b each, instead of one as illustrated in FIGS. 3a, 3b and 3c. The two agitator panels on each shaft are axially displaced from one another along the axial/longitudinal extent of the shaft and are circumferentially displaced from one another so that they project radially outwardly in different directions. In the FIG. 4 illustration, the two agitator panels on each shaft are diametrically opposed to each other (i.e., the agitator panels project radially outwardly in diametrically opposite directions).

As indicated by two arrows in FIG. 4, the two shafts are arranged to counter rotate. That is, the motor(s)/engine(s) which are connected to the shafts to rotate the shafts are controlled (e.g., by a controller such as an ECU) to rotate the shafts at the same time, but in opposite rotational directions. As viewed from the upper end in FIG. 4, one shaft (i.e., the shaft on the right in FIG. 4) is rotatably driven in the counter-clockwise direction while the other shaft (the shaft on the left in FIG. 4) is rotatably driven in the clockwise direction. An advantage of having counter rotating agitator panels is that the yield can be improved. With respect to the central region of the vat interior located between the two shafts, the agitator panels move through such central region in a common direction as illustrated in FIG. 4.

As discussed above, the agitator panels both cut and stir. If the rotation of the shafts depicted in FIG. 4 is performed to effect stirring, the motor(s)/engine(s) connected to the shafts are controlled to rotate the shafts in the opposite directions depicted in FIG. 4 to effect cutting.

If, as is the case illustrated, a distance between the shafts 402a, 402b is less than a combined length of the agitator panels (a combined length of the agitator panels=the length/radial extent of 406a+the length/radial extent of 404b) there will be a commonly swept volume 408, in FIG. 4 represented by the dotted region. By having the shafts placed such a commonly swept volume is achieved an interaction between the agitator panels is increased.

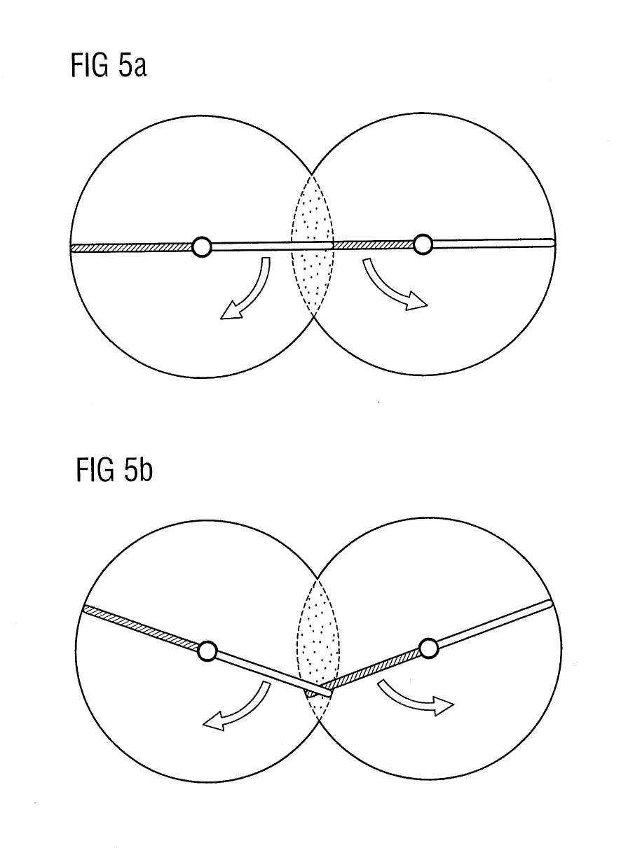

FIG. 5a and FIG. 5b illustrate a dual vertical cheese vat provided with counter rotating agitator panels in two different stages seen from above. Each shaft is provided with two agitator panels placed on top of each other and spaced apart 180°. For illustrative purposes, in FIGS. 5a and 5b, lower agitator panels are shaded and upper agitators are without shading.

In FIG. 5a and FIG. 5b the agitator panels are moving with the same rotational speed and are set to meet between the shafts, as illustrated in FIG. 5a. After having met the agitator panels move from each other as illustrated in FIG. 5b.

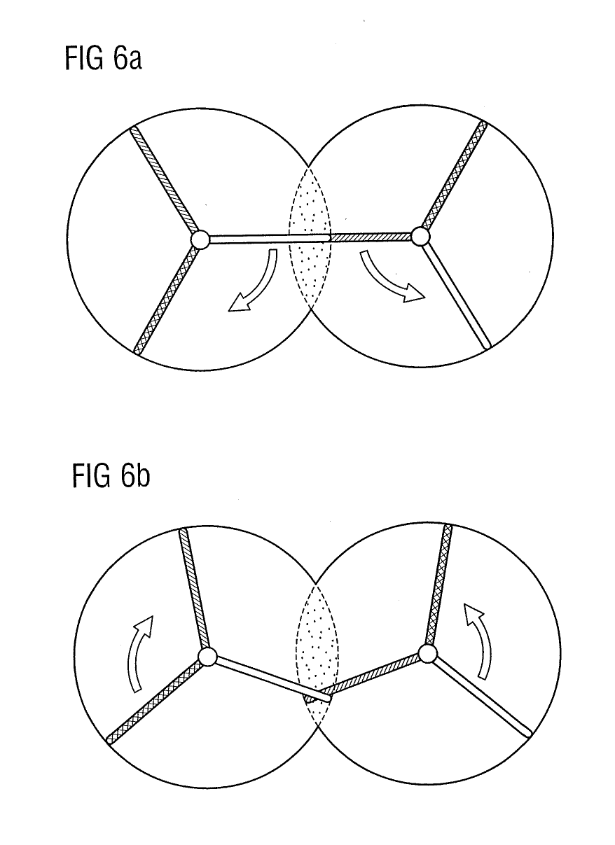

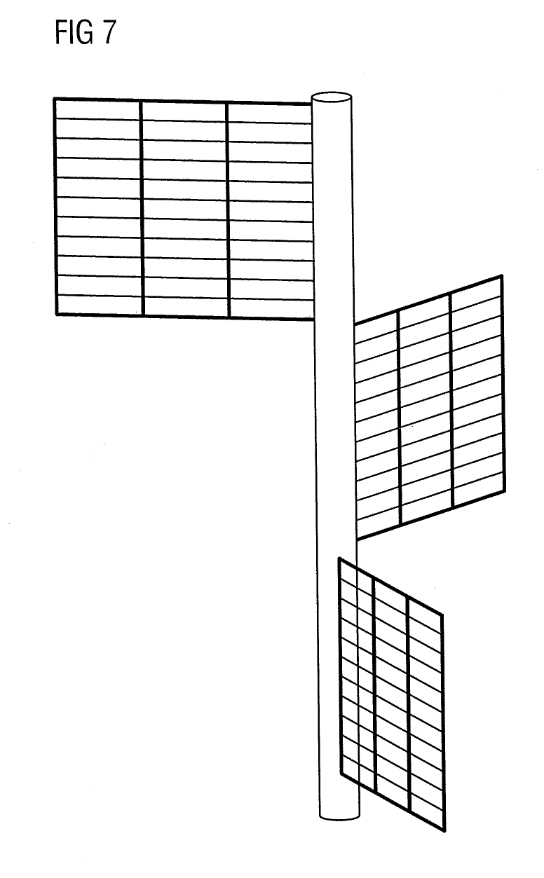

FIG. 6a and FIG. 6b illustrate a dual vertical cheese vat provided with three agitator panels spaced 120° apart from each other, seen from above, in two different stages.

The three agitator panels are placed on top of each other. An uppermost agitator panel is without shading, a middle placed agitator panel is shaded and a lowermost is cross shaded.

Although not illustrated, even further agitator panels can be used.

Further, the agitator panels do not have to be evenly distributed, but in order to reduce wear and to have a robust operation of the cheese vats it can be advantageous to have them evenly distributed.

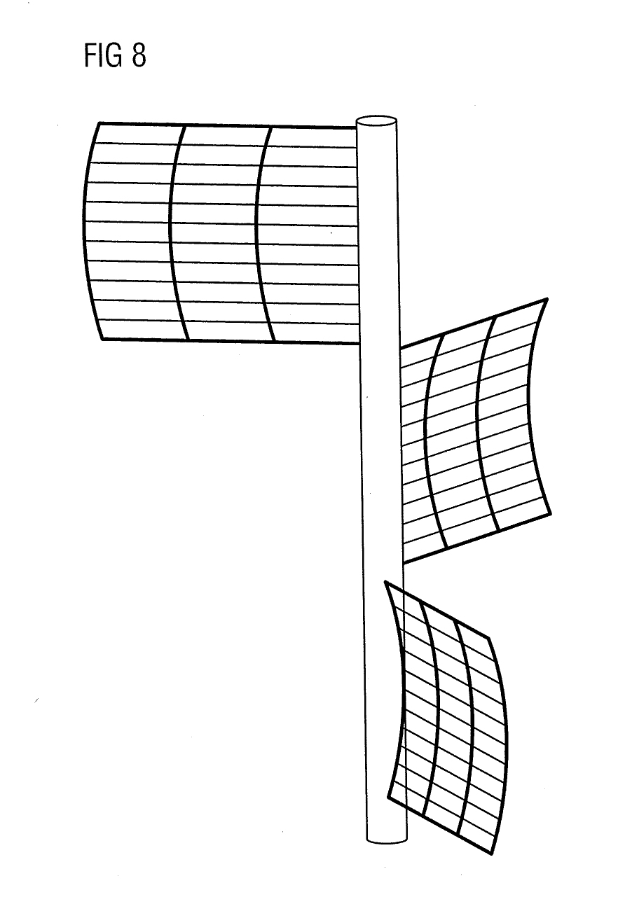

FIG. 7 schematically illustrates a perspective view of a shaft provided with three agitator panels spaced 120° apart from each other and placed above each other as the shaft and agitator panels illustrated in FIGS. 6a and 6b. Although not illustrated, the agitator panels may comprise of longitudinal elements and transversal elements placed at different distances from each other as illustrated in FIG. 3.

FIG. 8 illustrates a shaft with three agitator panels spaced 120° apart from each other and placed above of each other, but instead of having flat agitator panels as illustrated in FIG. 7, the three agitator panels are curved. The agitator panels may be parabolically curved, as illustrated, but other types of curvatures may be applied as well. Further, the curvature of the the agitator panels may vary between the different agitator panels. For instance, the lowermost agitator panels may have a curvature that is adjusted so that curd particles are pushed upwards while cutting. Still an option is to adjust the spacing between the transversal and/or longitudinal elements of the agitator panel to the curvature to get a high yield.

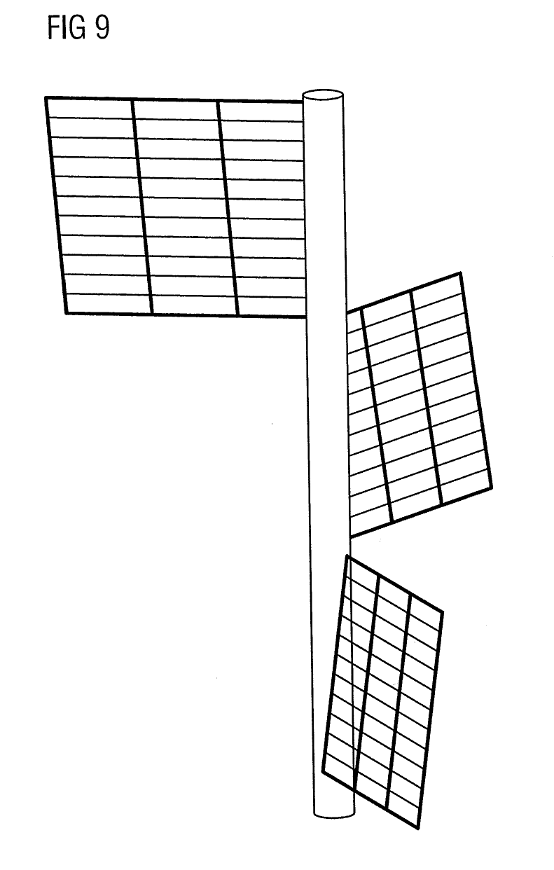

FIG. 9 illustrates a shaft with three agitator panels spaced 120° apart from each other and placed on top of each other, as the agitator panels illustrated in FIGS. 7 and 8, but unlike the agitator panels illustrated in FIG. 7 and FIG. 8 they are inclined. The agitator panels may for instance be inclined such that a lowermost portion of the agitator panels are sweeping the curd before an uppermost portion of the agitator panels, thereby providing for that the curd particles that are not cut are pushed upwards instead of falling down to the bottom of the vat.

Even though the panels illustrated in FIG. 9 are flat panels that are inclined, the agitator panels may as an alternative be curved and inclined.

Further, the inclination may vary for the different agitator panels. For instance, the lowermost agitator panels may be more inclined than the uppermost agitator panels, since it is more useful to push the curd upwards in a lower section of the cheese vat compared to an upper section.

Even though the vats described and illustrated herein are vats intended for cheese processing, or more particularly curd processing, the general principles may be applied in other fields as well, for instance holding tanks for liquid food products containing particles, such as orange juice with pulp.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A vertical vat comprising
a first shaft provided with at least one agitator panel,
a second shaft provided with at least one agitator panel,
wherein said first shaft and said second shaft are arranged to counter rotate.

2. The vertical vat according to claim 1, wherein said at least one agitator panel of said first shaft and said at least one agitator panel of said second shaft are arranged to sweep a common swept volume.

3. The vertical vat according to claim 1, wherein said first shaft and said second shaft are provided with at least two agitator panels each, wherein said at least two agitator panels are rotationally spaced apart from each other.

4. The vertical vat according to claim 3, wherein said first shaft and said second shaft are provided with two agitator panels each, said two agitator panels being 180 degrees spaced apart from each other.

5. The vertical vat according to claim 3, wherein one of said at least two agitator panels of said first shaft and one of said at least two agitator panels of said second shaft are arranged to sweep said common swept volume at the same time.

6. The vertical vat according to claim 1, wherein said at least one agitator panel of said first shaft and/or said at least one agitator panel of said second shaft comprise a number of cutting/stirring elements.

7. The vertical vat according to claim 1, wherein said at least one agitator panel of said first shaft and/or said at least one agitator panel of said second shaft have a curved surface.

8. The vertical vat according to claim 7, wherein a concave side of said curved surface is provided with sharpened edges.

9. The vertical vat according to claim 7, wherein a convex side of said curved surface is provided with blunt edges.

10. The vertical vat according to claim 1, wherein said at least one agitator panel of said first shaft is arranged such that a lower part of said agitator panel moves ahead of an upper part of said agitator panel such that particles are pushed upwards when sweeping.

11. The vertical vat according to claim 1, wherein said first shaft and second shaft rotate at a speed of 7 rotations per minute or less.

12. A shaft provided with at least one agitator panel, wherein said at least one agitator panel is inclined with respect to said shaft.

13. A method comprising:
feeding a liquid or semi-liquid food product into a vertical vat, the vertical vat comprising a first shaft provided with at least one agitator panel and a second shaft provided with at least one agitator panel, wherein said first shaft and said second shaft are arranged to counter rotate; and
stirring and/or cutting said food product by sweeping said at least one agitator panel of said first shaft and said at least one agitator panel of said second shaft through said food product.
